(19) United States
(12) Patent Application Publication
(10) Pub. No.: US 2015/0036451 A1
(43) Pub. Date: Feb. 5, 2015

(54) Livestock feed mixer monitoring system and method

(71) Applicant: Robert J. Buresh, North Field, MN (US)

(72) Inventor: Robert J. Buresh, North Field, MN (US)

(21) Appl. No.: 13/987,525

(22) Filed: Aug. 3, 2013

(51) Int. Cl. B01F 15/00

(52) U.S. Cl. CPC B01F 15/00123
USPC 366/142; 366/143

(57) ABSTRACT

A microwave moisture probe is used in a system and method to measure completeness of mixing in portable total mixed ration (TMR) feed mixers. The probe continuously monitors the moisture concentration of the feed mix and communicates its readings to a processor. The processor processes the data from the probe and determines when the feed has been mixed optimally. The processor then communicates with a display to provide a signal to a user.

### PRIORITY CLAIM

This application claims priority to U.S. provisional patent application No. 61/742,165 entitled “Livestock Feed Mixer Monitoring System and Method” filed Aug. 3, 2012.

### FIELD OF THE INVENTION

The present invention relates to a system and method for monitoring the completeness of feed mixing for livestock. More particularly, the present invention relates to using microwave technology to implement such a system and method in portable total mixed ration (TMR) livestock feed mixers.

### BACKGROUND OF THE INVENTION

Microwave moisture measurement technology has been used to monitor livestock feed mixing in fixed feed mills. (see e.g., “Microwave Moisture Measurement” in Grain and Feed Milling Technology, January 2008, pp. 14-16; and Hydronix publication “The Benefits of Using Digital Microwave Moisture Measurement”). However, the problems and challenges of feed mixing in fixed mills differ from those involved with portable TMR mixers. In particular, the ration ingredients vary more in type and consistency. It is therefore desirable to develop new systems and methods employing microwave moisture measurement technology for portable TMR mixers.

### BRIEF DESCRIPTION OF THE INVENTION

A microwave moisture probe is used in a system and method to measure completeness of mixing in portable total mixed ration (TMR) feed mixers. The probe continuously monitors the moisture concentration of the feed mix and communicates its readings to a processor. The processor processes the data from the probe and determines when the feed has been mixed optimally. The processor then communicates with a display to provide a signal to a user.

### BRIEF DESCRIPTION OF THE DRAWINGS

The accompanying drawings, which are incorporated into and constitute a part of this specification, illustrate one or more embodiments of the present invention and, together with the detailed description, serve to explain the principles and implementations of the invention.

In the drawings:

FIG. 1 depicts the components of the feed monitoring system, such components mounted in a portable TMR mixer.

FIG. 2 depicts a vertical style portable TMR mixer with a prototype of the system installed.

FIG. 3 depicts a microwave sensor attached to a vertical style portable TMR mixer.

FIG. 4 depicts a control box attached to a vertical style portable TMR mixer.

FIG. 5 depicts a prototype display.

FIG. 6 is a flow chart showing the steps for collecting data to optimize mixing of a ration.

### DETAILED DESCRIPTION

Embodiments of the present invention are described herein in the context of a system and method to optimize feed mixing in a portable TMR feed mixer. Those of ordinary skill in the art will realize that the following detailed description of the present invention is illustrative only and is not intended to be in any way limiting. Other embodiments of the present invention will readily suggest themselves to such skilled persons having the benefit of this disclosure. Reference will now be made in detail to implementations of the present invention as illustrated in the accompanying drawings. The same reference indicators will be used throughout the drawings and the following detailed description to refer to the same or like parts.

In the interest of clarity, not all of the routine features of the implementations described herein are shown and described. It will, of course, be appreciated that in the development of any such actual implementation, numerous implementation-specific decisions must be made in order to achieve the developer's specific goals, such as compliance with application- and business-related constraints, and that these specific goals will vary from one implementation to another and from one developer to another. Moreover, it will be appreciated that such a development effort might be complex and time-consuming, but would nevertheless be a routine undertaking of engineering for those of ordinary skill in the art having the benefit of this disclosure.

The present invention is a system and method for optimizing the mixing of livestock feed in a portable TMR mixer. TMR mixers present unique challenges to livestock and dairy producers. Better feed mixes produce faster growth in cattle and hogs, and more milk production in dairy cattle. An often overlooked aspect of feed mixing, especially on the farm, is the adequacy of the degree of mixing of specialized livestock feeds. The present invention provides a system and method for improving mix quality.

A livestock feed mixture may contain many components, including but not limited to: alfalfa, grass, corn stalks, straw, by-products from ethanol production, liquid whey, silage, grains, hay, vitamins, and minerals. Additionally, water may be added to improve moisture content. Ideally, the mix should be fed to the livestock as a uniform substance. Nutrients and other components should be uniformly distributed within the feed. Until the present invention, preparing TMRs using portable mixers did not allow for immediate and accurate quantitative data to optimize mixing.

Components, quality and consistency of a feed mixture may vary from day to day. Availability of some components changes according to season and other factors such as nutritional value, cost and availability. Components stored outside (e.g., in a feed bunker) will change according to the weather. Additionally, the mixer itself will change over time as it wears, gradually altering its mixing characteristics. Because of these variables, optimal mixing time and speed is a continually moving target. Besides allowing determination of complete mixing for an individual mix, the system of the invention provides data for a user to observe and identify mixing patterns where adjustment may lead to improvement of mixing methods and mixture quality as processes change. Determining the best order of adding components, determining the best method of adding components, controlling addition of water and other liquids during mixing, and identifying components that don't mix well and require pre-processing or pre-mixing are areas in which the invention is useful.

Optimized mixing is important. There are two main considerations. First, achieving complete mixing results in better nutrition and more effective use of feed components. Second, complete mixing must be balanced against overprocessing, because mixing reduces particle size. Beyond a certain degree, overprocessing reduces the quality of the ration or mix, sometimes to the point of ruining the mix. For dairy cattle a completely mixed ration, compared to a partially mixed ration, is worth about an extra two pounds of milk per cow per day on average. Similar effects can be seen in other agricultural production environments.

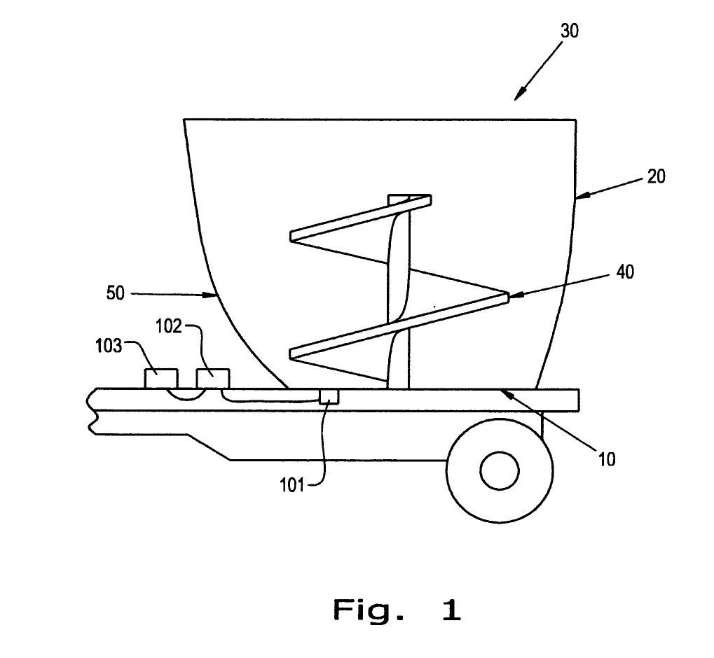

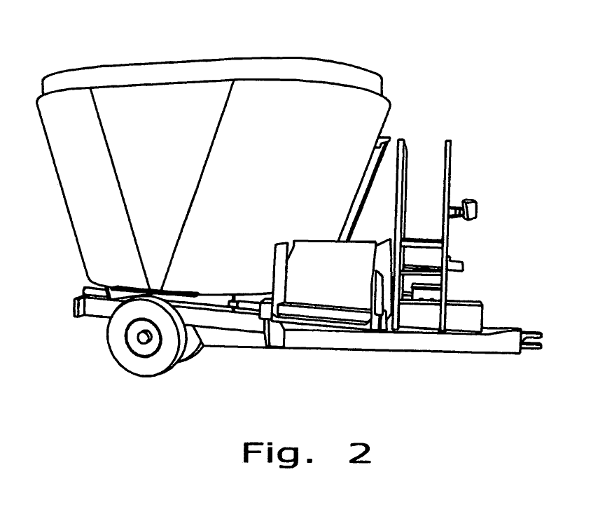

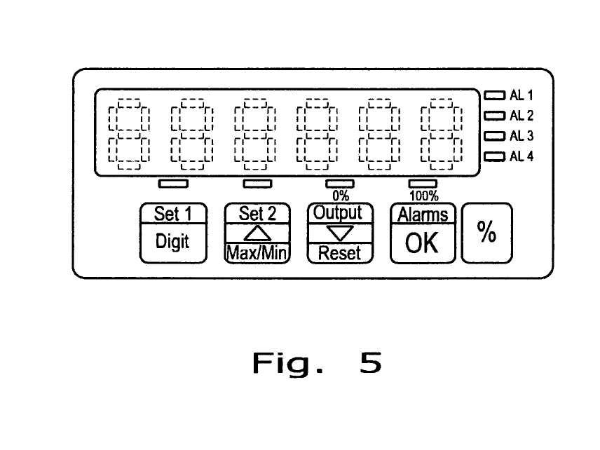

To achieve a completely mixed ration, the system of the invention comprises several components. FIG. 1 depicts the components of the feed monitoring system, such components mounted in a portable TMR mixer shown in cross section. Probe 101 is mounted on the bottom wall 10 of mixer tank 20 of portable mixer 30. As the mixer screw 40, or other equivalent mixing actuator(s), mix the feed components that have been added to the mixer tank, probe 101 continually emits a microwave signal and captures returning signals. The data from the returning signals may be used to calculate moisture content of the material in the mixer. While determination of complete mixing of feed is the object of the invention, this is achieved by relating the moisture content data to the degree of mixing as described below. Probe 101 communicates with processor 102, which monitors and processes the moisture content data of the feed until mixing is complete. Processor communicates with display 103, which provides information to the user regarding the status of the mixing process. The system may also include a control box (202 in FIG. 4) to house the processor or a processing unit, power connections, power converter, and display. The processor may comprise a plurality of separate units. For example, the probe assembly may incorporate a processor and the control box may house a separate processing unit.

The invention uses moisture content data collected by the probe to determine completeness of mixing. The components of a feed ration may have a wide variety of moisture contents. For example, minerals have very low moisture content. Dry corn may have a moisture content of about 15%. Liquid whey may have moisture content as high as about 80-90%. When initially added to the feed mixer, the components are not dispersed homogeneously, and the moisture content of the mix is uneven throughout. As mixing proceeds, however, the moisture content detected by the probe begins to approach a uniform value. The processor is programmed to determine when the moisture content of the feed mix is sufficiently uniform. Preferably, complete mixing is indicated by moisture within the mix varying by less than about five percent. More preferably, complete mixing is indicated by moisture within the mix varying by less than about three percent. Display 103 indicates to user when complete mixing is achieved.

The system and method employ commercially available microwave probes. Both fixed frequency and multi-frequency probes are compatible with the invention (see Hydroinix publication). Probes send out a signal of one or more known frequencies and receive a reflected signal that is shifted by the moisture content of the material being sampled. The probes send out microwave signals (e.g., 840 megahertz). In an air environment the probe will give a zero reading, indicating no moisture content. In a 5% saline solution, a 100% moisture reading is obtained (for an 840 megahertz emitted signal, a 822 megahertz signal is returned). The probe takes many readings every second, and a processer supplied with the probe averages the recent return signals and provides and output reading of moisture content. Fixed frequency probes require calibration to provide accurate moisture content data, though relative moisture content data is still useful for the invention. Multi-frequency digital probes can provide accurate moisture content data without calibration.

The invention may be employed simply using the processor and display available with commercially available probes. However, it is advantageous to provide additional processing power and algorithms for application specific purposes. Such processing may include calculating the mean, the standard deviation, the coefficient of variation, and/or the relative standard deviation (RSD) of the moisture content of the feed being mixed. The RSD (which is the absolute value of the coefficient of variation) is particularly useful for determining when mixing is complete. A 5% RSD is preferable, and a 3% RSD is most preferable to judge complete mixing. In a preferred embodiment, the processor accepts input from the user to set a target RSD and sends a signal to the display when the target is achieved. The processing algorithm may include a minimal time before RSD is calculated to ensure that the ration is actually mixed. The processing algorithm uses only the most recent moisture content data to calculate the RSD. In a preferred embodiment, only the moisture content data from the last minute is used to calculate RSD. More preferably, only the data from the last 30 seconds is used. While RSD is the preferred value to calculate, calculation of any similar value that indicates stabilization of the moisture content is within the scope of the invention.

Although much is currently unknown, from Penn State shaker box and trace element determinations it is estimated that dairy and beef rations are considered relatively well-mixed under current practices at 5% RSD. However, such complete mixing not often achieved, and the Penn State shaker box and trace element methods do not provide real-time mixing data to the user.

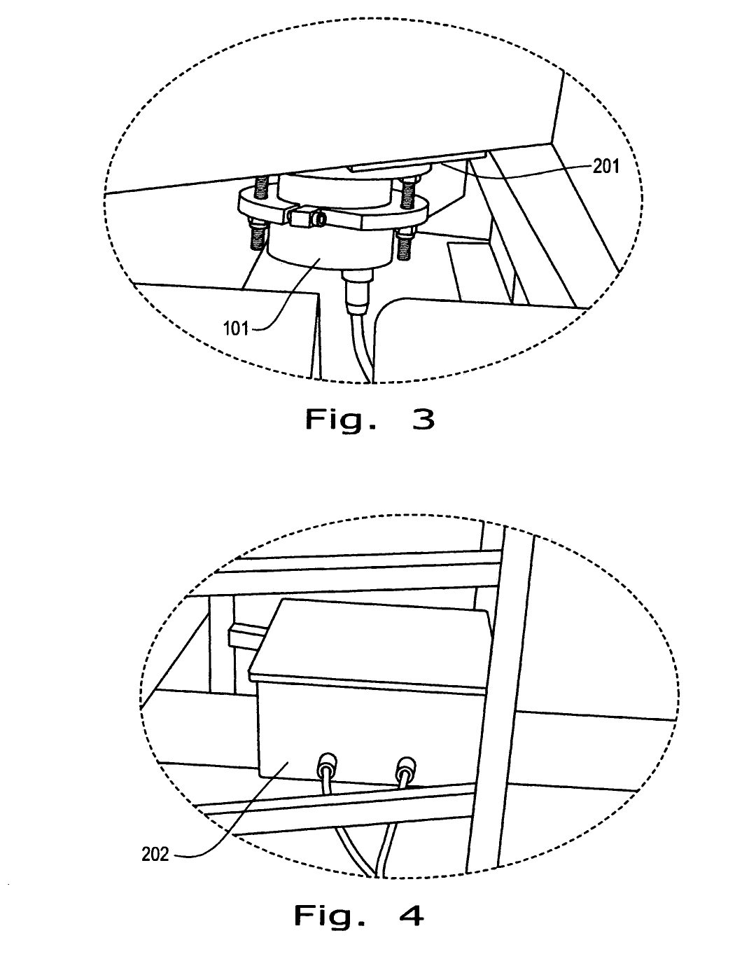

The location of probe within the mix tank is an important consideration. The probe captures its return signals from a “dome” about five inches into the material being sampled, i.e., a volume of about 60-65 cubic inches, which is a small volume in the context of a 40,000 pound mixer. For mixers of the vertical style as shown in FIG. 1, the probe is optimally positioned on the bottom wall of the mix tank, several inches inside the end of the lower part of the screw. Preferably, the probe is positioned on the bottom wall 10 between about one and 20 inches from the side wall 50 of the mix tank, as shown in FIG. 3. More preferably, the probe is positioned between about one and four inches from the side wall 50 of the mix tank. The surface of the probe is preferably mounted flush with the bottom wall of the mixer tank so that together the probe surface and bottom wall form a smooth and even surface. Such a position on the bottom wall exposes the probe to consistent pressure (inconsistent pressure may affect readings) in an area that is not continually disrupted by the screw. Further, this position provides a balance between consistent exposure to the feed mix against minimal turbulence produced by the mixing screw. Also, this location has good material flow in the area to be sampled.

The probe is adjustably mounted, as shown in FIG. 3. Mounting bracket 201 is welded to the bottom wall 10 of the mixer. Bracket 201 is designed to position probe 101 through an opening in the bottom wall so that the surface of the probe is flush with the upper surface of the bottom wall. The surface of the probe is typically a ceramic disc that is more durable than the steel of the bottom wall. Because of this, the bracket is adjustable so that the position of the probe may be lowered as the bottom wall erodes.

The invention has been exemplified in this application with a vertical style feed mixer. Presently, vertical style mixers generally have a capacity between about 3,500 to 40,000 pounds, and the invention may be applied to such mixers of any size. The invention may also be employed in other types of portable TMR mixers besides the vertical style mixer. Such other TMR mixers include horizontal auger, reel, apron and tumble. In any style of mixer, the probe is preferably positioned so that it is subject to constant pressure from the feed mix, with relatively minimal turbulence from the mixing mechanism, and good material flow over the surface of the probe.

The processor receives moisture content data from the probe and continually monitors and processes such data until mixing is complete. The results of the processing are transmitted to one or more displays so that mixing progress can be monitored by the user. The processor may perform calculations with the data in a number of different ways to produce a meaningful result. Typically the processing includes averaging recent sets of data points received from the probe. The processor may accept input requests from the user for purposes of calibration, selecting a display, transferring or retrieving data, selecting a target variance parameter, and the like. Other desirable processing capabilities include accepting detailed information concerning about the mix components and the ability to export such data to remote locations.

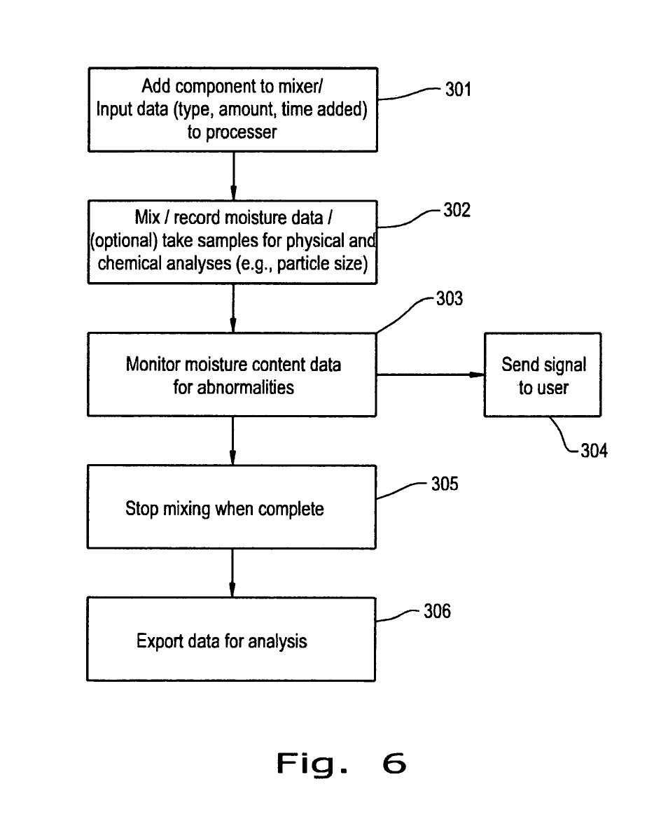

The display preferably comprises an LED panel as exemplified in FIG. 5. One useful display function is to continually show the most recent moisture content. Another useful display is the present RSD. As the mix proceeds, this allows a user to monitor the rate and progress of mixing. Other useful display functions include an alarm when the mixing is complete, an automated phone call to the user when the mixing is complete, automatic shut off of the mixer, and transfer of mixing data to a database.

The invention also encompasses a method of improving mixing procedures and mixture quality, as well as determining when there is a problem with mixing an individual ration. FIG. 6 is a flow chart showing the steps for collecting data to optimize mixing of a ration. In step 301 the components are added to the mixer and, for each component, data is fed to the processor. Such data may include the type of component, the amount added, and the time of addition. It is worth noting that not all components are optimally added at time zero. It is sometimes better to premix some components before adding others. In step 302 the mixing process is started and moisture content data is continually collected by the probe and sent to the processor. Samples of the mixing ration may also be taken during the mixing process for separate physical and chemical analyses. In step 303 the mixing is monitored by the processor. Using input data regarding mixing components, real-time moisture content data, and preprogrammed algorithms, the system may detect problems with the current mixing process. For example, if a certain combination of components is taking longer than usual to mix, the processor may send an error signal to the display indicating the abnormality (step 304). As another example, if the RSD does not achieve the target RSD value after a certain time, a different error signal may be sent to the display (step 304). If there is a problem with the current mix, the user can decide how to handle it. Alternatively, if the mix goes to completion without a problem the display will provide a signal to that effect and the mixing can be stopped (step 305). At step 306 the data is exported for analyses, including comparisons of mix data and production data and how they relate. Such analyses may result in mixing improvements such as determining the best order of adding components, determining the best method of adding components, and identifying components that don't mix well and/or require pre-processing or pre-mixing.

In one aspect, the invention is a system for monitoring the degree of feed mixing in a total mixed ration mixer where the system comprises a microwave probe mounted to the wall of the mixer, said probe emitting microwave signals and collecting return data; a processor, said processer using the data to calculate when mixing is complete; and a display, said display indicating when mixing is complete. The probe is preferably mounted to the bottom wall of the mixer. The mixer may be a vertical style mixer with the probe positioned between about 1 and 20 inches from the side wall. More preferably the probe is positioned between about 1 and 4 inches from the side wall. The position of the probe is adjustably mounted so that the position of the probe may be lowered as the bottom wall erodes.

In another aspect, the invention is a system for monitoring the degree of feed mixing of a feed ration in a portable total mixed ration mixer where the system comprises a microwave probe mounted to the bottom wall of the mixer, said probe emitting microwave signals and collecting return data; a processor, said processer using the most recent data to calculate the RSD of the moisture content of the feed ration; and a display, said display indicating the RSD. The mixer may be a vertical style mixer having an outer wall, and the probe may be located between one and ten inches of the outer wall. The display may send a signal when the RSD falls below a preset value. The preset value may be about five percent. The most recent data may include data from the previous 60 seconds. The most recent data may include data from the previous 30 seconds. The processor may accept input data on the components of the feed ration.

In another aspect, the invention is a method of mixing a feed ration in a portable total mixed ration mixer where the method comprises adding components of the ration to the mixer; using a microwave probe to collect moisture content data from the ration as it is being mixed; calculating the RSD of the most recent moisture content data; and sending a signal to the display when the RSD falls below a preset value. The mixer may be a vertical style mixer having a bottom wall and an outer wall, and the probe is located on the bottom wall between one and ten inches of the outer wall. The preset value may be about five percent. The most recent data may include data from the previous 60 seconds. The most recent data may include data from the previous 30 seconds.

In another aspect, the invention is a method of monitoring the mixing of a feed ration in a portable total mixed ration mixer having a monitoring system including a microwave probe, a processer and a display where the method comprises adding components of the ration to the mixer; inputting data about the components to the processer; mixing the ration while collecting moisture content data from the probe; calculating the RSD of the most recent moisture content data; and sending a signal to the display when the RSD falls below a preset value. The mixer may be a vertical style mixer having a bottom wall and an outer wall, and the probe may be located on the bottom wall between one and ten inches of the outer wall. The preset value may be about five percent. The most recent data may include data from the previous 60 seconds. The most recent data may include data from the previous 30 seconds. The method may further comprise monitoring the moisture content data during mixing for abnormalities and sending a signal to the display in the event of an abnormality. The method may further comprise exporting the data from the processor for analysis.

It is one object of the invention to optimize meat and dairy production by optimizing the feed mix provided to livestock. It is a further object of the invention to save time and money by providing an accurate determination of when mixing in a portable MIR mixer is complete. It is another object to prevent overprocessing of the feed mix, which overprocessing may entail undesirable reduction in feed texture. It is another object to provide real-time data on the completeness of mixing in a portable mixer. It is another object to improve on previous monitoring methods, such as visual inspection or a Penn State shaker box test. It is another object of the invention to identify flawed feed mixing procedures.

Some microwave moisture probes require calibration in order to provide dependably accurate reading of moisture content. Variables such as particle size and density affect the data collected. In the present invention, however, accuracy of the moisture content data is typically not always critical. Instead, the stabilization of the probe reading as mixing approaches completion is most important. Therefore, calibration of the probe for specific feed mixes is not always required. If water is added to optimize the feed mix, a precalibrated probe is adequate to determine approximate final water concentration.

Livestock refers to all agricultural production animals, including but not limited to beef cattle, dairy cattle, hogs and poultry.

While embodiments and applications of this invention have been shown and described, it would be apparent to those skilled in the art having the benefit of this disclosure that many more modifications than mentioned above are possible without departing from the inventive concepts herein. The invention, therefore, is not to be restricted except in the spirit of the appended claims.

What is claimed is:

1. A system for monitoring the degree of feed mixing in a total mixed ration mixer where the mixer has a bottom wall and a side wall, the system comprising:
a microwave probe mounted to the wall of the mixer, said probe emitting microwave signals and collecting return data;
a processor, said processer using the data to calculate when mixing is complete; and
a display, said display indicating when mixing is complete.

2. The system of claim 1, where the probe is mounted to the bottom wall of the mixer.

3. The system of claim 2, where the mixer is a vertical style mixer and the probe is positioned between about 1 and 20 inches from the side wall.

4. The system of claim 3, where the mixer is a vertical style mixer and the probe is positioned between about 1 and 4 inches from the side wall.

5. The system of claim 2, where the position of the probe is adjustably mounted so that the position of the probe may be lowered as the bottom wall erodes.

6. The system of claim 1, where the processor calculates the RSD value of the return data.

7. A method for monitoring the degree of feed mixing in a total mixed ration mixer where the mixer has a bottom wall and a side wall and a microwave probe mounted to the bottom wall of the mixer, the method comprising:
using the probe to emit microwave signals and collect return data; and
processing the data to calculate when mixing is complete.

8. The method of claim 7, comprising the further step of sending a signal to a user when mixing is complete.

9. The method of claim 7, comprising the further step of turning off the mixer when mixing is complete.

10. The method of claim 7, where the mixer is a vertical style mixer and the probe is positioned between about 1 and 20 inches from the side wall.

11. The method of claim 7, where the mixer is a vertical style mixer and the probe is positioned between about 1 and 4 inches from the side wall.

12. The method of claim 7, where said processing includes calculating RSD values.

13. A method for improving mixing procedures in a total mixed ration mixer where the mixer has a bottom wall and a side wall and a microwave probe mounted to the bottom wall of the mixer, the method comprising:
adding feed components to the mixing,
recording data about the components;
mixing the components;
using the probe to emit microwave signals and collect return data during mixing; and
using the return data from the probe along with production data from feeding the mix to livestock to optimize further mixing procedures.

14. The method of claim 13, where the mixer is a vertical style mixer and the probe is positioned between about 1 and 20 inches from the side wall.

15. The method of claim 13, where the mixer is a vertical style mixer and the probe is positioned between about 1 and 4 inches from the side wall.
